(19) United States
(12) Patent Application Publication
(10) Pub. No.: US 2008/0053384 A1
(43) Pub. Date: Mar. 6, 2008

(54) Piston having diode laser hardened primary compression ring groove and method of making the same

(75) Inventors: John M. Haake, St. Charles, MO (US); Kevin Corgan, Caseyville, IL (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NUVONYX, INC., Bridgeton, MO (US)

(21) Appl. No.: 11/892,384

(22) Filed: Aug. 22, 2007

Related U.S. Application Data
(60) Provisional application No. 60/839,412, filed on Aug. 23, 2006.

(51) Int. Cl. F01C 1/07; B23K 26/00; C21D 1/09

(52) U.S. Cl. 123/18 R; 148/525; 29/888.043

(57) ABSTRACT

A piston having a head includes a circumferential compression ring groove having a top surface, a bottom surface and an inset rear wall extending between the top surface and the bottom surface, wherein a confined area of the compression ring groove is hardened.

### CROSS REFERENCE TO RELATED APPLICATIONS

The present application is related to U.S. Provisional Patent Application No. 60/839,412 filed on Aug. 23, 2006, to Corgan et al., entitled “PISTON HAVING DIODE LASER HARDENED PRIMARY COMPRESSION RING AND METHOD OF MAKING SAME”, which is incorporated, in its entirety, herein by reference.

### BACKGROUND OF THE INVENTION

1. Field of the Invention

The present invention relates to a piston having a hardened primary compression ring groove and the method of making same. More particularly, the invention relates to the use of a diode laser in hardening surfaces of the primary groove of a piston.

2. Description of the Related Art

A piston, such as one proposed for use in an engine, takes much abuse during its function. Further, to keep forces of combustion taking place against a head of the piston, from escaping around the piston, a plurality of compression rings are seated about the circumference of the piston, each ring engaging within a groove for same provided in the circumference of the piston head.

It is known that the land defining a bottom surface of the primary ring groove is stressed significantly because the impact force and scrubbing or scuffing force during each combustion episode is borne primarily by the first compression ring, and usually by the bottom landing, but can also be the top landing.

To accommodate the stress and wear placed upon the land defining the bottom surface of the primary groove, the area of the piston head incorporating the primary groove presently is unhardened or hardened by induction hardening. Such induction hardening affects a large cross sectional area of the piston head surrounding the ring groove, hardening this volume of the piston head to no functional advantage. Rather, such large cross sectional area hardening has been found to be detrimental to longevity of the piston, often leading to stress cracking of the dome or combustion head surface of the piston. In addition to deforming the machined surface to cause additional time consuming grinding because the part is now hardened such that low cost machining cannot be performed.

In addition the induction hardening process heat treats much more metal than required to achieve the desired results. This leads to distortion of the piston landings, which have to be held at very high tolerance for engine longevity. Thus, the induction-hardened pistons have to go through subsequent and expensive machining to achieve the tolerance necessary of longevity.

In addition, the induction process is uncontrollable due to the fact that the process relies on the precise gap being maintained all the way around the perimeter of the area to be heat treated, and the inductor coils. This is difficult for implementing a high volume manufacturing environment. In addition, liquid quenching is required during the induction heat-treating process, as a turbulent water based process, which is naturally unpredictable and has low process stability, and is an environmental and hazardous waste disposal problem.

Furthermore, Diesel engine manufacturer AE Goetzer, part of the auto components group Turner & Newell, used CO₂ laser hardening treatment on piston components to help extend the maintenance interval between engine overhauls. Medium speed diesel engines have traditionally used aluminum pistons with reinforced upper ring grooves. When the company switched to tougher steel and cast iron pistons, it discovered rapid wear at the ring groove faces, particularly when using lower grade fuels. Attempts to use induction hardening to increase the durability of the piston proved unsuccessful.

Laser hardening using optical beam scanning equipment provided a solution. The technique achieved groove hardening in both steel and cast iron pistons to a depth of 0.5 mm without the surface melting or significant distortion of the sensitive region around the groove land. The project enabled the company to improve the lifetime of the pistons.

### SUMMARY OF THE INVENTION

In view of the foregoing and other exemplary problems, drawbacks, and disadvantages of the conventional methods and structures, an exemplary feature of the present invention is to provide a method and structure in which a diode laser is used to harden a primary compression ring.

According to a first exemplary aspect of the invention, a piston having a head includes a circumferential compression ring groove having a top surface, a bottom surface and an inset rear wall extending between the top surface and the bottom surface, wherein a confined area of the compression ring groove is hardened.

According to another exemplary aspect of the invention there is provided a piston having a head incorporating therein at least a primary circumferential compression ring groove defined by a top surface, a bottom surface and an inset rear wall extending between the top and bottom surfaces. The bottom surface only, specific areas of the bottom surface only or the bottom surface area and specific areas of the back wall are heat-treated.

Still further according to another exemplary aspect of the invention there is provided a method of laser hardening at least a portion of a primary circumferential compression ring groove of a piston, when the method includes positioning a laser so that a rectangular beam spot is formed on a bottom surface of the groove, or top surface, and rotating the piston so the entire circumferential extent of the bottom surface of the groove is intersected by the beam for a predetermined period of time. In the present invention it is not necessary to coat the groove with a graphite solution. The present invention utilizes a diode laser, which does not require the metal to be coated for absorption due to the shorter optical wavelength.

Furthermore, the diode laser has a preferred and natural beam shape that is rectangular in shape. Accordingly, the direct diode laser can be used directly without the need for expensive integrating optics, which is required for CO₂ lasers.

In accordance with an exemplary feature of the present invention, a diode or semiconductor laser is used to harden only one of the functional areas of the primary ring groove defined by the bottom or top landing of the groove surface. This hardening process significantly increases piston head longevity. The laser diode hardening process significantly reduces the distortion as compared to induction heat treating the piston, thus re-machining after laser heat treat is not required. The direct diode laser process is much more controllable and predictable as compared to induction hardening. The diode laser is a solid state laser that has no gas resonators like a CO₂ laser. Therefore, the diode laser has a very high response rate. In addition, unlike CO₂, the diode laser is constructed for the incoherent combination of many diode lasers, which allows for a very uniform spot without special hot spots. The diode laser also eliminates the need for environmentally unfriendly quenching fluids and eliminates the need for environmentally unfriendly paints and absorbing coatings that are used with the CO₂ laser.

As compared with the traditional CO₂ laser, the direct diode laser also does not require a time-consuming-application of absorption coatings. This is due to the fact that the diode laser has a wavelength that is much shorter (e.g., 800 nm, which is closer to UV), and is much more absorbing than the CO₂ laser, which has a wavelength of 10.6 microns.

Furthermore, unlike laser hardening using a CO₂, laser the diode laser hardening can be performed without the environmentally unfriendly and expensive pre-coating of the piston to increase optical absorption.

In addition, the diode laser can be designed with a preferred polarization such that the polarization of the laser beam is p-polarization with respect to the metal surface, which is of interest. This polarization is known by those skilled in the art as TM polarization at the bar. TM or P-Ray (P-polarized) light has been shown to be more absorbing on metal surfaces than TE (transverse electric) or S-Ray (S-polarization). This has a great benefit in that the p-polarized light is highly absorptive and does not reflect off the metal surface in which the light hits at steep angles with respect to normal. This high degree of absorption means that the light from the diode is highly controllable with respect to the area to be heat treated. The ability to precisely control the location of heat treatment as a result of the high degree of absorption is extremely important so that areas of the groove that are not required to be heat treated do not get heat treated. Heat treatment in areas that are not required can be detrimental to the use of the piston.

An additional feature of the present invention is that the focus of the direct diode laser can be made such that the focal point is below the surface of the bottom landing. This configuration greatly benefits the heat treatment since the laser beam is more in focus toward the back of the groove, which is harder to heat up because it is farther from the edge. The focus toward the back directs more intensity toward the back, which creates a flatter heat treat.

Moreover, the diode laser is constructed to have a preferred polarization, which is p-polarization.

Still further according to an exemplary aspect of the present invention, a temperature feedback control can be used to control the temperature in situ using high speed modulation or control bandwidth, which allows for high speed control.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 is a side view of a piston illustrating a diode laser being used to harden a primary ring groove thereof in accordance with the present invention;

FIG. 2 is a slightly enlarged view similar to FIG. 1 illustrating a bottom landing of a ring groove being heat treated;

FIG. 3 is an enlarged cross sectional view through the area of the primary compression ring groove illustrating the land defined area hardened by the laser;

FIG. 4 illustrates a surface of a ring groove being illuminated by a laser beam from a diode laser in accordance with an exemplary embodiment of the present invention;

FIG. 5 illustrates a laser beam from a diode laser in accordance with an exemplary embodiment of the present invention being focused below a surface of the bottom landing on the top piston ring groove;

FIG. 6A illustrates the polarization emitted from a bar, which is focused and preserved down to a part that is heat treated with a direct diode laser light in accordance with an exemplary aspect of the present invention;

FIG. 6B is a pictorial description of the intensity profile distribution when focusing below the surface;

FIG. 7 illustrates an exemplary intensity profile change across the surface of the bottom groove when a laser beam from the diode laser is focused inside of the part;

FIG. 8 illustrates how a uniform intensity profile upon a surface of interest creates a non-uniform heat treatment;

FIG. 8A illustrates how the non-uniform intensity profile due to focusing below the surface of from a custom optic creates the desirable heat treatment profile;

FIG. 9 depicts a graph illustrating the relationship of the reflectivity versus the angle of incidence for P-polarization and S-polarization;

FIG. 10 illustrates a diode laser beam directed on the centerline of a piston ring groove; and

FIG. 11 illustrates a diode laser beam directed off center of the piston ring groove.

### DETAILED DESCRIPTION OF EXEMPLARY EMBODIMENTS OF THE INVENTION

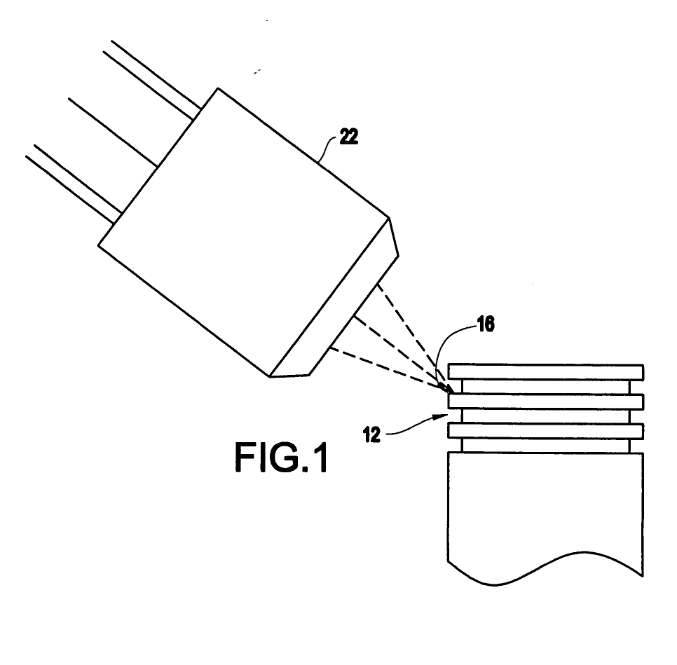

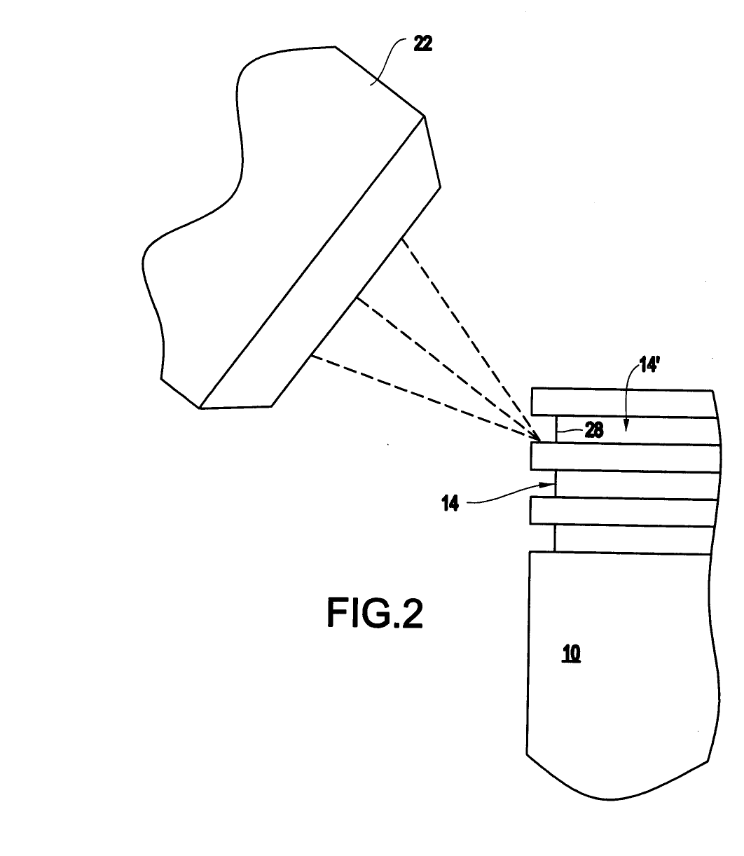

Referring now to the drawings, and more particularly to FIGS. 1-11, there are shown exemplary embodiments of the method and structures according to the present invention.

Referring now to the drawings in greater detail, there is illustrated therein a piston having a laser hardened primary compression ring groove bottom surface defining land, the piston being generally referred to by the reference numeral 10.

As shown in FIGS. 1-3, the piston 10 includes a head portion 12 which has a plurality of circumferential piston ring grooves 14 therein, a primary one of which is labeled 14′.

This primary groove 14′ has a bottom surface 16 which is defined by a primary land 18, the land 18 having chamfered outer corners 20.

Presently, the area of the piston head 12 incorporating this primary compression ring groove 14′ is hardened by the process of induction. Such induction hardening causes a brittleness and distortion of the metal material, leading to cracking of the piston head 12, and the cylinder wall, as well as to chipping away of the bottom surface 16 of the primary groove 14′ in the area adjacent the chamfered corner 20.

The damage is caused by the blow by pressure exerted against the primary land 18 by a primary compression ring (not shown) during normal operation of a combustion engine, which seats within the primary groove 14′, engaging against a wall of the piston cylinder (not shown) for maintaining the forces of combustion taking place against the head 12 confined, generating power to run an engine (not shown).

Thus, the bottom surface 16 of the primary compression ring groove 14′ must be hardened to endure the concussive and scuffing abuse caused there by the compression ring, without compromising the structural integrity of the piston head 12 in the area being hardened.

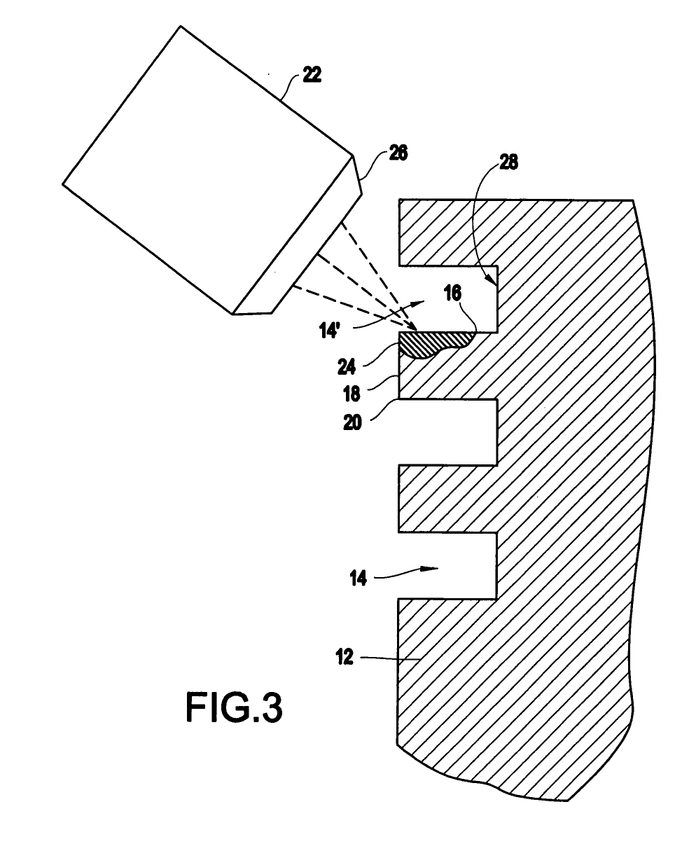

Such hardening, which does not compromise structural integrity of the piston head 12, may be reproducibly accomplished by using a diode laser 22 which is operable to harden a confined area 24 of the primary groove 14′, without causing brittleness in the primary land 18, and without compromising structural integrity of the remainder of the piston head 12 (e.g., see FIG. 3).

In this respect, Applicants have discovered through empirical testing that a beam may be produced from a diode laser, which intersects the bottom surface 16 of the primary compression ring groove 14′ in a particular manner to produce the precise hardening desired.

The beam is produced by the diode laser to have a wavelength of 800 nm ±10 nm. However, such direct aiming is not possible, and it has been found that when the laser beam 26 is angled approximately 32 degrees from horizontal, a rectangular/elliptical spot measuring approximately 0.15 inch by 0.75 inch may be created on the bottom surface 18 of the primary groove 14′, hardening the bottom surface 18 in the area 24 shown in FIG. 3.

The heat treatment in FIG. 3 is applied to the bottom surface 16 of the land 18, and not to the back surface 28.

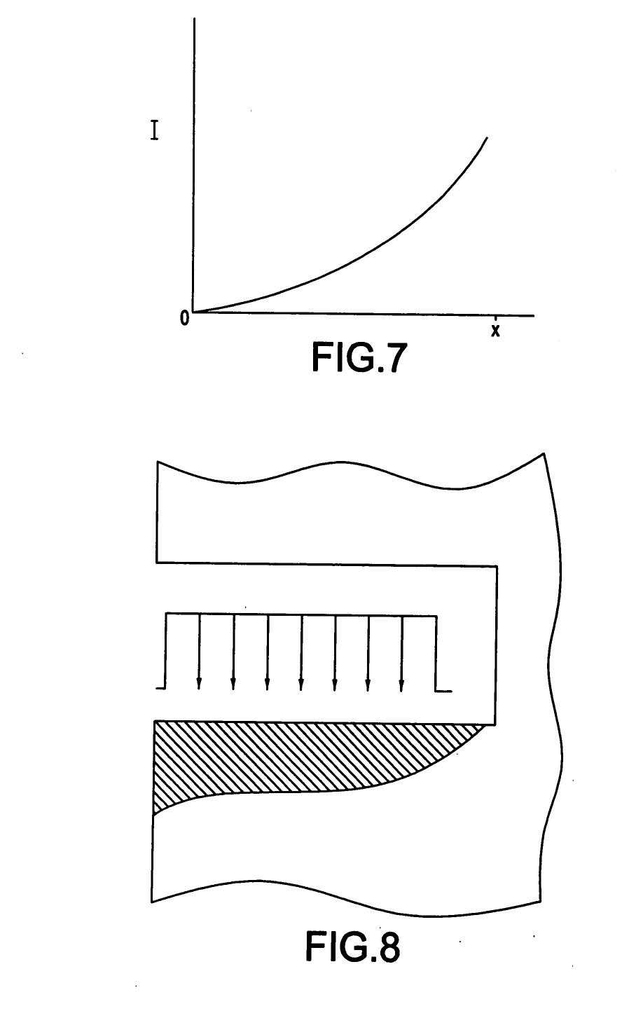

The focus of the direct diode laser is configured such that the focal point is below the surface of the bottom landing (this feature is further described below with reference to FIGS. 5 and 7). This focus configuration greatly benefits the heat treatment since the laser beam is more in focus toward the back of the groove, which is harder to heat up because it is farther from the edge. The focus toward the back directs more intensity toward the back, which creates a flatter heat treatment, due to the fact that the heat flux from the surface is now matched with the heat flux into the surface from the 15 diode laser.

It will be understood that the groove 14 is circumferential and that it is to be treated by laser in its entire circumferential extent. This may be accomplished by known means, such as by placing the piston 10 on a turntable (not shown) and rotating the piston 10 (the revolution taking slightly longer than a minute when beam parameters described above are used). It is desirous to create a slight overlap of the starting point during rotation, to accommodate any variations that may be incurred in rotational speed of the turntable.

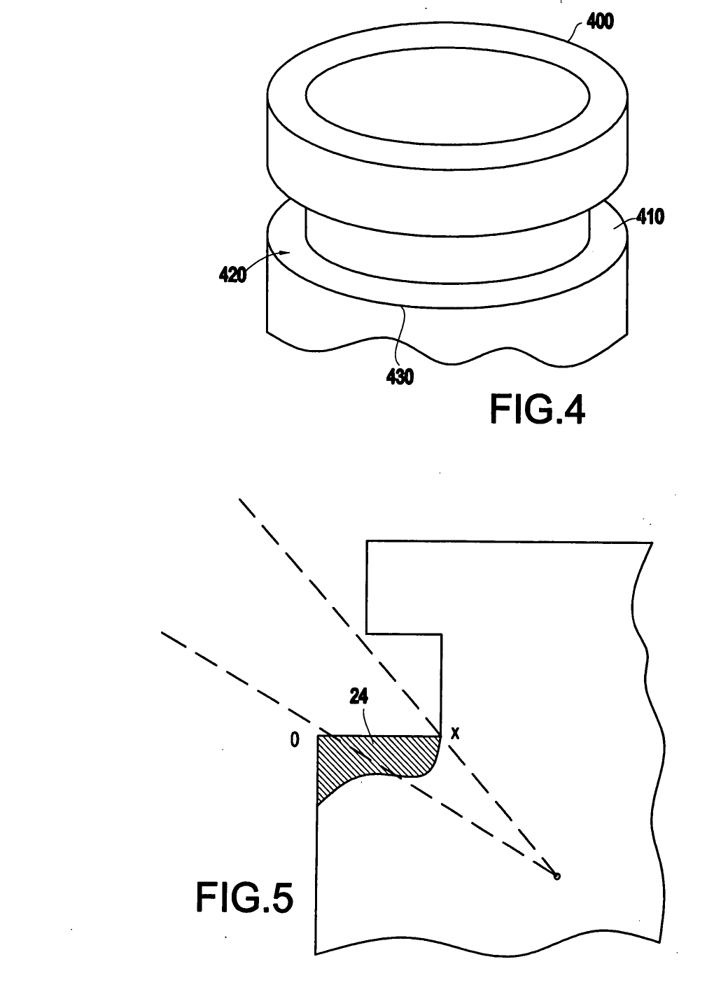

FIG. 4 illustrates a piston 400 having a piston ring groove 410 disposed thereon. The piston ring groove 410 includes a bottom landing groove 420. The rectangular laser beam spot 430 is focused on the bottom landing groove 420. The diode laser is used to heat treat the bottom landing groove 420 at the focused laser beam spot 430 without treating the back wall. The diode laser may also be used to heat treat a top portion of the piston ring groove 410.

FIG. 5 illustrates an exemplary focusing of a laser beam from a diode laser in accordance with an exemplary embodiment of the present invention to a point below the surface of the bottom ring groove (as mentioned above, the diode laser beam may also be focused on the top ring groove).

As indicated above, the focus of the direct diode laser is made such that the focal point is below the surface of the bottom landing (as shown in FIG. 5). This focus configuration greatly benefits the heat treatment since the laser beam is more in focus toward the back of the groove (e.g., point x), which is harder to heat up because it is farther from the edge (e.g., point 0). The focus toward the back directs more intensity toward the back, which creates a flatter heat treatment.

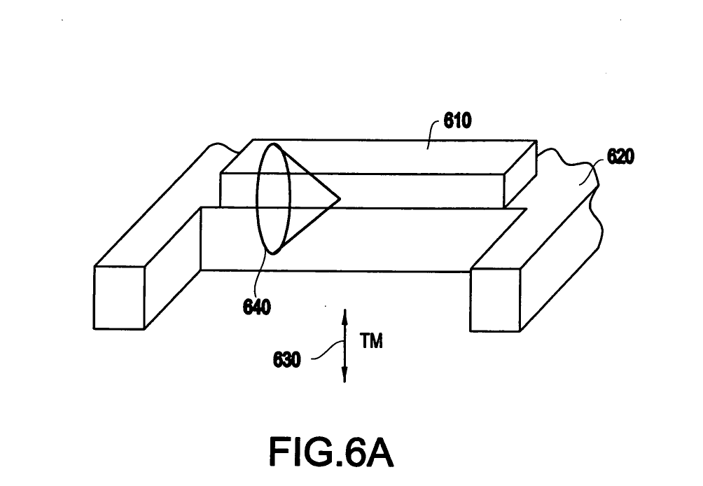

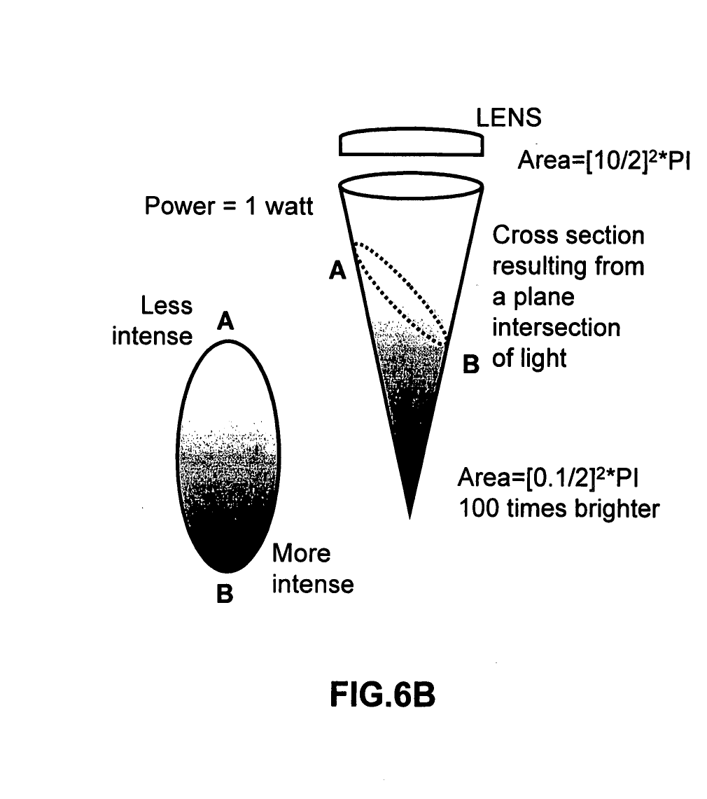

FIG. 6A illustrates the polarization 630 of a laser beam 640 emitted from a bar 610 mounted on a heat sink 620 that is focused and preserved down to a part that is heat treated with the direct diode laser. FIG. 7 shows the intensity profile change across the surface of the bottom groove due to the diode laser beam being focused inside of the part.

The intensity [I] is directly proportional to where one measures it in a focusing laser beam. For example, let a laser beam be round and start off with a 10 cm diameter. Using a 10 cm focal length lens, this would form a spot 10 cm away. If the minimal focal spot size at the focus is 1 mm [0.1 cm] and the laser beam has a total power of 1 w and the lens has no loss, then the lens surface intensity (also know as power density) [I]=Power/surface area [{10/2}cm²*PI].

At the focus spot, the beam is only 0.1 cm in diameter so the intensity is 100 times greater. For a round beam, the focused laser light can be represented as a cone, in which the intensity goes from less intense to more intense (see FIG. 6B).

FIG. 6B also illustrates an intersection of the cone of light by a plane, which is represented by an ellipse in which the intensity across the ellipse varies from less intense at A than at B. With a direct diode laser, the beam is made up of many laser diode bars, which, when emitting laser light, can be circumscribed by a rectangle. Thus, instead of a round beam, the laser diode produces a rectangular beam. Therefore, when the surface plane of the piston groove intersects a focusing beam and the beam is focused below the surface, one achieves a variation in the intensity in which it is more intense toward the back than in the front. Additionally, the shape of this beam using a direct diode laser is rectangular and uniform along the line tangent to the circumference of the piston. This has a unique benefit for heat treating, because this type of intensity profile closely matches that which is needed to achieve a uniform heat treat from front to back without melting the edge designated as 0 in FIG. 3.

The reason that this is beneficial is that for every point on the surface of the bottom of the piston ring groove, those points toward the back require more heat flux or energy density (energy density=power density* time) to achieve the desired heat treatment temperature as compared to those points toward the edge. The reason for this is that those points on the surface away from the edge have more cold metal mass for the heat to flow to from the surface (e.g., heat flux). Therefore, the laser beam is more intense in the back of the groove where more heat is required.

That is, the closer one gets to the focus of the laser beam, the higher the intensity the laser light is on the surface. This compensates for the fact that the thermal heat transfer profile is the opposite of this (i.e., there is more heat flux off the surface toward the middle of the part as compared to that away from the edge of the part). This also is beneficial in that the part will melt preferentially toward its edge.

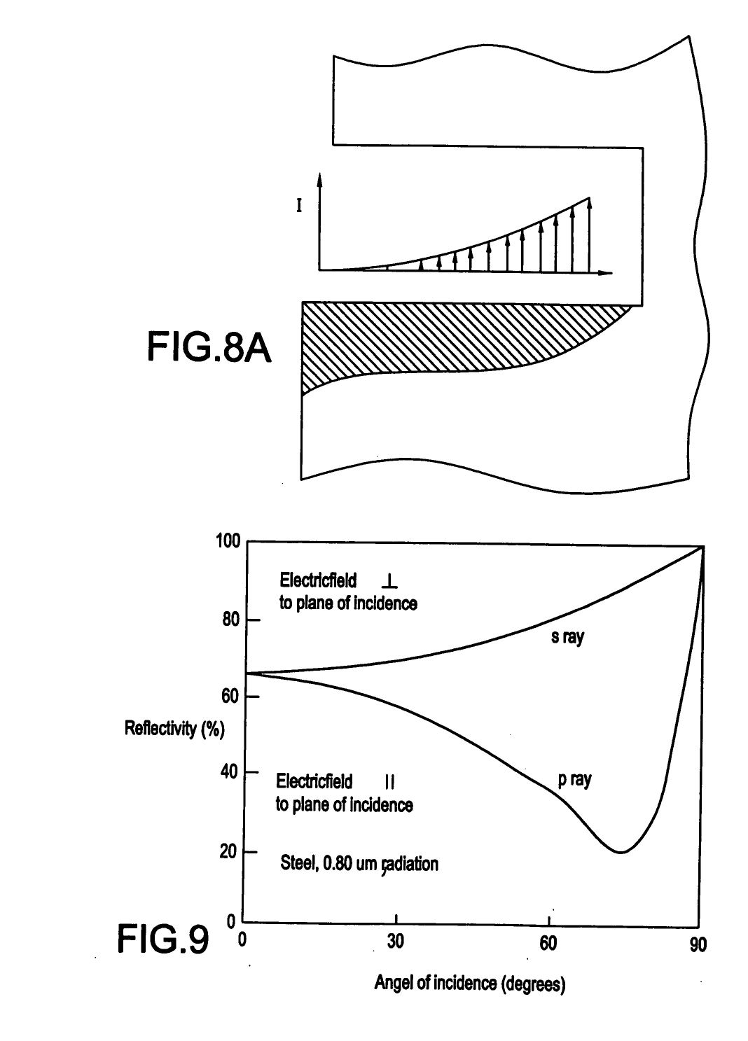

FIG. 8 depicts a uniform illumination or application of heat, such as that which would come from induction. This uniform heat application would produce a non-uniform heat treatment profile due to the fact that the heat sink/heat conduction away from the surface is not uniform. Therefore, edges and corners heat up higher and quicker than portions that are deeper into the groove. This heat uniformity and how it leaves the heated area is important for obtaining a hardened case.

The heat treatment includes heating the steel up past the austenizing temperature and rapidly quenching the part by self quench (e.g., a laser process) or by a quenchant (e.g., induction). If the heat treated area is brought below the martensitic critical temperature within the required period of time, the result is a martensitic structure.

Polarization refers to the E field component of the laser light. A diode laser may have a preferred polarization that can be either described as Transverse Electric [TE] or Transverse Magnetic [TM].

Light is an electromagnetic radiation, which is made up of magnetic and electrical fields that are 90 degrees out of phase. The light beams from the diode laser are polarized sometimes in the plane of the junction of a laser diode bar and sometimes perpendicular to it. These correspond to Transverse Electric [TE] and Transverse Magnetic [TM] respectively.

The arrangement of the laser diode bars in a stack is such that they are parallel to each other. Therefore, the polarization of the direct diode laser head is such that the polarization is maintained the same as a single laser diode bar. During the process, the long axis of the focused direct diode laser beam may be parallel with the junction.

FIG. 8A illustrates how the non-uniform intensity profile due to focusing below the surface of from a custom optic creates the desirable heat treatment profile.

FIG. 9 illustrates the sensitivity of the absorption coefficient for a metal surface to the polarization of the E-Field. Specifically, FIG. 9 depicts an absorption curve versus the incident angle of the emitted laser. The E-field perpendicular to the plane of incidence is the S-Ray and this is from a TE polarized bar. The E-Field parallel to the plane of incidence is the P-ray and this is from a TM polarized bar. This figure illustrates that a polarized light provides a great benefit for heat-treating surfaces that are highly angled with respect to the impinging laser.

More specifically, it can be seen that for high angles of incidence for the P-polarized light, the reflectivity drops significantly and therefore absorption of the light radiation increases by a corresponding amount. Using purely P-polarized light at high angles of incidences maximizes the amount of light energy absorbed by the material.

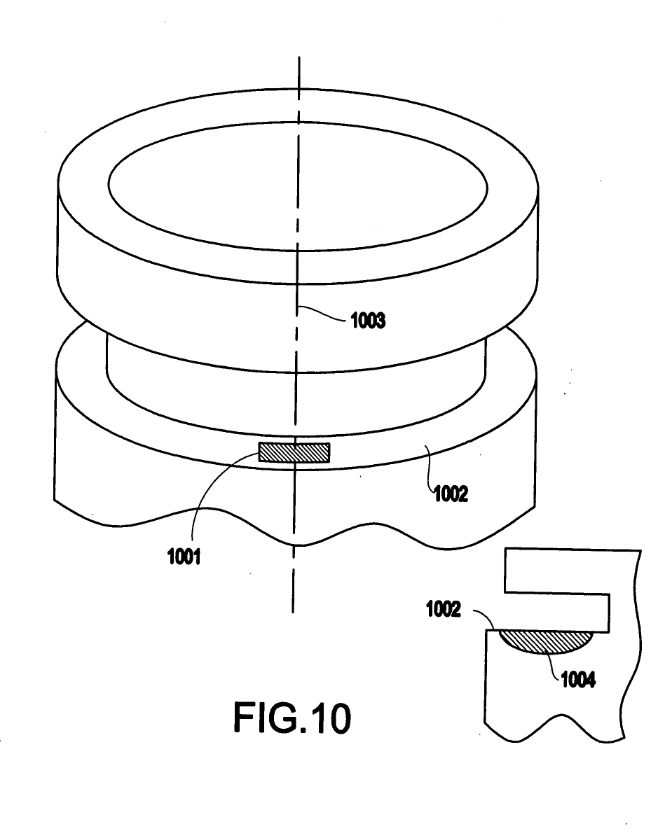

FIG. 10 depicts the application of the diode laser beam 1001 directed on the centerline 1003 of a piston ring groove 1002 where the ring groove is deeper than the width of the spot size.

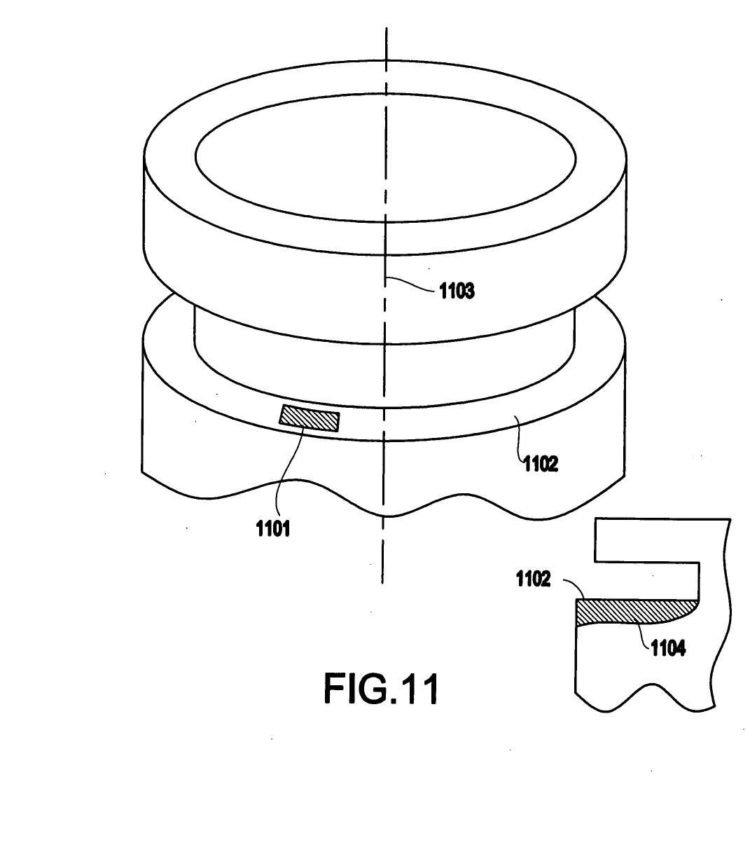

FIG. 11 depicts the application of the diode laser beam 1101 directed off the centerline 1103 of a piston groove 1102 when the groove is deeper than the width of the spot size.

As can be seen when comparing FIGS. 10 and 11, the placement of the diode laser beam can have a dramatic effect on which area of the groove is heat-treated (e.g., 1004 and 1104). The rectangular shape of the diode laser beam naturally provides the ability, by moving the beam within the circular confines of the ring groove, to easily change the surface area heat treat coverage.

In accordance with a further, exemplary aspect of the present invention, a temperature of the surface of the workpiece can be dynamically controlled by measuring the temperature of the surface. The quickest way to measure the temperature of a surface that is being heat treated by a laser beam is the use of, for example, a pyrometer or a thermal camera. This is a non-contact measurement of the surface temperature. Furthermore, this is the quickest way to measure the surface temperature and since the laser only heats the surface this is a highly suitable way to measure the process temperature.

Using a control loop, the laser emits radiation that heats the part and then, the pyrometer measures radiation coming form the heated part. Accordingly, the pyrometer can convert the measured surface temperature into an electrical signal or image, which can be used in a control feedback loop to dynamically control the temperature of the surface of the part.

According to an exemplary embodiment of the present invention, there is a piston having a head incorporating therein at least a primary circumferential compression ring groove defined by a top surface, a bottom surface and an inset rear wall extending between the top and bottom surface, a portion of the bottom surface toward the rear wall being hardened by direct laser contact with or without the rear wall being heat treated, with the top surface being maintained unhardened.

According to another exemplary embodiment, the present invention includes a piston having a head incorporating therein at least a primary circumferential compression ring groove defined by a top surface, a bottom surface and an inset rear wall extending between the top and bottom surface, a portion of the bottom surface toward the rear wall being hardened by direct laser contact with or without the rear wall being heat treated, with the top surface being maintained unhardened or unaffected by the laser on the other landing.

A method of laser hardening a portion of a primary circumferential compression ring groove of a piston, includes positioning a laser so that a rectangular beam spot is formed on a portion of the bottom surface of the groove toward a rear wall of the groove to avoid direct contact between the beam and a chamfered edge of the bottom surface and further to avoid direct contact of the beam and top surface and rear wall of the groove, and rotating the piston about a axis of the piston so the entire circumferential extent of the portion of the bottom surface of the groove is intersected by the beam for a predetermined period of time. The diode laser does not need the metal to be coated with an environmentally unfriendly absorber for enhanced absorption due to the shorter wavelength and polarization.

The piston is rotated about an axis of the piston so the entire circumferential extent of the portion of the top surface of the groove is intersected by the beam for a predetermined period of time, wherein one rotation takes approximately less than one minute.

As mentioned above, according to certain exemplary embodiments of the present invention, the laser beam is produced by a diode or semiconductor laser. The laser beam is produced by an array of N laser diodes. The N direct diode laser are used simultaneously, circumferentially around the piston to heat treat the landings (top and bottom) simultaneously.

The natural beam spot is approximately rectangular and has an aspect ratio of 6:1 (in certain exemplary embodiments a W6 lens is used, which provides a 12 mm×6 mm spot) with the long axis extending tangentially along the bottom surface of the ring. Furthermore, the spot has a preferred polarization of TM at the direct diode laser bar, which corresponds to a p-polarization at the metal surface. As preferred polarization of p at the metal surface.

The wavelength of the laser beam is between 500 nm and 1000 nm. The beam is angled at approximately 32 degrees to the horizontal. The diode laser has a preferred optical polarization which is perpendicular to the long axis of the laser beam.

While the invention has been described in terms of several exemplary embodiments, those skilled in the art will recognize that the invention can be practiced with modification within the spirit and scope of the appended claims.

Further, it is noted that, Applicants' intent is to encompass equivalents of all claim elements, even if amended later during prosecution.

What is claimed is:

1. A piston having a head comprising:
a circumferential compression ring groove having a top surface, a bottom surface and an inset rear wall extending between the top surface and the bottom surface,
wherein a confined area of said compression ring groove is hardened.

2. The piston according to claim 1, wherein said confined area comprises less than an entirety of said compression ring groove.

3. The piston according to claim 1, wherein said confined area comprises a portion of at least one of the top surface and the bottom surface of said compression ring groove.

4. The piston according to claim 1, wherein the inset rear wall of said compression ring groove is unhardened.

5. A method of forming a piston having a head, comprising:
forming a compression ring groove in the head, said compression ring groove having a top surface, a bottom surface and an inset rear wall extending between the top surface and the bottom surface; and
hardening a confined area of said compression ring groove using a diode laser.

6. The method according to claim 5, wherein said hardening comprises positioning the diode laser so that a beam spot is formed on a portion of a bottom surface of said compression ring groove toward a rear wall of said compression ring groove.

7. The method according to claim 6, wherein said hardening further comprises avoiding contact between the beam and a chamfered edge of the bottom surface, the top surface, and the rear wall of said compression ring groove.

8. The method according to claim 5, wherein said hardening comprises rotating the piston about an axis of the piston so the bottom surface of the groove is intersected by a beam of the diode laser for a predetermined period of time.

9. The method according to claim 6, wherein said hardening comprises rotating the piston about an axis of the piston so the bottom surface of the groove is intersected by a beam of the diode laser for a predetermined period of time.

10. The method according to claim 5, wherein the diode laser produces a rectangular beam.

11. The method according to claim 5, wherein said hardening comprises rotating the piston about an axis of the piston so an entire circumferential area of the bottom surface of the groove is intersected by a beam of the diode laser for a predetermined period of time.

12. The method according to claim 5, wherein said confined area comprises less than an entirety of said compression ring groove.

13. The method according to claim 5, wherein said confined area comprises a portion of at least one of the top surface and the bottom surface of said compression ring groove.

14. The method according to claim 5, wherein the inset rear wall of said compression ring groove is unhardened.

15. The method according to claim 5, wherein the diode laser produces a beam having a p-polarization.

16. The method according to claim 5, wherein the diode laser produces a beam having a TM-polarization.

17. The method according to claim 5, wherein a focal point of the diode laser is below a bottom surface of said compression ring groove.

18. A piston having a head comprising:
at least a primary circumferential compression ring groove defined by a top surface, a bottom surface and an inset rear wall extending between the top surface and the bottom surface,
wherein a portion of the top surface toward the rear wall is hardened by direct diode laser contact with or without portions of the rear wall being heat treated, with the bottom surface being maintained unhardened by the laser on another landing.

19. A method of hardening a surface of a compression ring groove formed in a piston head comprising the steps of:
generating a linearly polarized radiation beam from a laser diode;
directing the beam at an angle with respect to radially extending surface of the groove in a manner to create p-polarized radiation; and
rotating the piston with respect to the beam to harden the radially extending surface.

20. A method as recited in claim 19, further including the step of focusing the beam to a location below the radially extending surface.
